(19) United States
(12) Patent Application Publication
(10) Pub. No.: US 2012/0030475 A1
(43) Pub. Date: Feb. 2, 2012

(54) MACHINE-MACHINE AUTHENTICATION METHOD AND HUMAN-MACHINE AUTHENTICATION METHOD FOR CLOUD COMPUTING

(76) Inventors: Felix Kuo-We MA, Zhonghe City (TW); Kuo-Neng Lan, Zhonghe City (TW); Chang-Wei Yang, Zhonghe City (TW); Kao-Huang Lin, Zhonghe City (TW)

(21) Appl. No.: 12/848,747

(22) Filed: Aug. 2, 2010

(51) Int. Cl. H04L 9/32; H04L 9/00

(52) U.S. Cl. 713/186; 380/259

(57) ABSTRACT

A Machine-Machine Authentication method and a Human-Machine Authentication method for Cloud Computing. A Smart Card IC that includes a TPM/TCM/USB key function module and a storage memory, and a bio-feature identification method are used to achieve the Machine-Machine Authentication and Human-Machine Authentication. The Machine-Machine Authentication uses the Smart Card IC to achieve an authentication between the Server and the Client, and the Human-Machine Authentication uses the bio-feature identification method to achieve an authentication between the user and the Client or the user and the Server.

### BACKGROUND OF THE INVENTION

1. Field of the Invention

The present invention relates to a Machine-Machine Authentication method and a Human-Machine Authentication method for Cloud Computing. More particularly, the present invention uses a Smart Card IC that includes a TPM/TCM/USB key function module and a storage memory, and a bio-feature identification method to achieve the Machine-Machine Authentication and Human-Machine Authentication.

2. Description of the Prior Art

For now, most applications for Cloud Computing aim at putting services, such as mail, text file, picture, game, online game, Facebook, Youtube, MSN, QQ, and etc in a server, such as a company server collocation service.

In these service structures, the server is configured to serve billions of Clients. Due to the limitation of the service structure, the present Cloud Computing technologies can only take Server-to-User authentication, which means user a name/password structure. The user, at any Client, can input the correct user name and password to login the Server for accessing data. Using a similar structure, data security is maintained by the Server provider and the Client user. The Server provider aims at protecting the Server and data from being attacked by hackers and being stolen. The Client user aims at protecting the personal data and the user name and password from being stolen by a Trojan program spread by hackers. Although the Server provider and the Client user both aim at maintaining the security of the system, wiretapping still provides a channel for the hackers to attack the system. Although a personal computer can be well secured by TPM and biological authentication, such as fingerprint authentication, at an affordable price, these authentications can only protect a personal computer and the data stored in a personal computer. Once it comes to Cloud Computing, the hackers can easily steal Cloud Computing data by wiretapping an internet communication.

Ideal Cloud Computing, which means the real definition of Cloud Computing, sets up all software and hardware in the Cloud Computing side, except for a monitor, keyboard, and mouse. That is, the hardware, such as the CPU, chip set, memory, hard disk, and etc, and the software, such as the OS, office, business tooling, engineer tooling, and etc, are all set up in Cloud Computing side, and the user can finally use a high-level computer anywhere. Under ideal Cloud Computing structure, the user can use the high-level computer in the Cloud Computing side via any mobile phone, simple computer, TV, and etc that has a screen and an input device. The computer located in Cloud Computing side is known as a virtual computer.

The aforementioned ideal Cloud Computing structure, without a strong enough data security application, would perform at a lower data security level than the present Cloud Computing security level. The main reason is, under the present Cloud Computing structure, the users only store unimportant data in the Cloud Computing side. For important or confidential data, the users store them in a personal computer/personal storage device, or a company computer/company storage device. The data stored in the Cloud Computing side, due to the publication policy of the Cloud Computing server, is highly possible to be attacked, while on the contrary, the computer put in a home or company would not be attacked when it is offline from the internet, and the users only have to prevent the real thieves from slipping into the house or company.

Thus, the previous data security structure would directly or indirectly block the ideal Cloud Computing structure from being widely promoted to the public.

### SUMMARY OF THE INVENTION

The primary objective of the present invention is to provide an authentication method for Cloud Computing, which applies a smart card IC to achieve a Machine-Machine Authentication between the Server and the Client.

Another objective of the present invention is to provide an authentication method for Cloud Computing, which applies Bio-identification to achieve a Human-Machine Authentication between the user and the Client, or the user and the Server.

The methods to achieve the aforementioned Machine-Machine Authentication and Human-Machine Authentication for Cloud Computing aim at using a smart card IC including function modules of a TPM/TCM/USB Key and a storage memory and being able to process Bio-identification. For Machine-Machine Authentication, the smart card IC is configured to link a Server and a Client, then the Server and the Client process a cross authentication. For Human-Machine Authentication, a Bio-identification method is applied to retrieve the Bio-features of user to achieve the Human-Machine Authentication between the user and the Client, or the user and the Server.

### BRIEF DESCRIPTION OF THE DRAWINGS

The drawings disclose an illustrative embodiment of the present invention which serves to exemplify the various advantages and objects thereof, and are as follows:

FIG. 1 shows a system structure block diagram of the Machine-Machine Authentication method and the Human-Machine Authentication method for Cloud Computing of the present invention;

FIG. 2 shows a flow chart of the Machine-Machine Authentication method for Cloud Computing of the present invention; and

FIG. 3 shows a flow chart of the Human-Machine Authentication method for Cloud Computing of the present invention.

### DETAILED DESCRIPTION OF THE PREFERRED EMBODIMENT

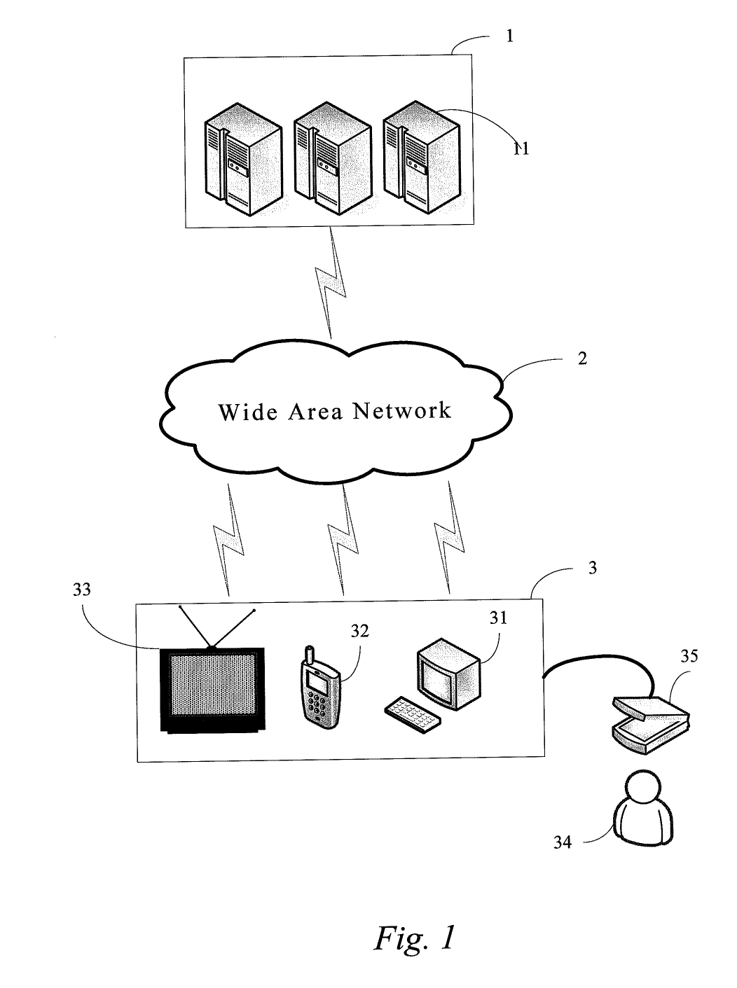

FIG. 1 shows a system block diagram of the present invention of a Machine-Machine Authentication method and a Human-Machine Authentication for Cloud Computing. The Machine-Machine Authentication method applies a smart card IC to link the Server 1 and the Client 3 via a local area network (LAN) or a wide area network (WAN) 2. Then the Server 1 and the Client 3 are configured to process a cross authentication to enhance the security of Cloud Computing.

The Human-Machine Authentication method of the present invention applies a Bio-identification method. A bio-feature detector 35 is configured to retrieve the bio-features of user 34 to achieve the Human-Machine Authentication between the user 34 and the Client 3 or the user 34 and the Server 1.

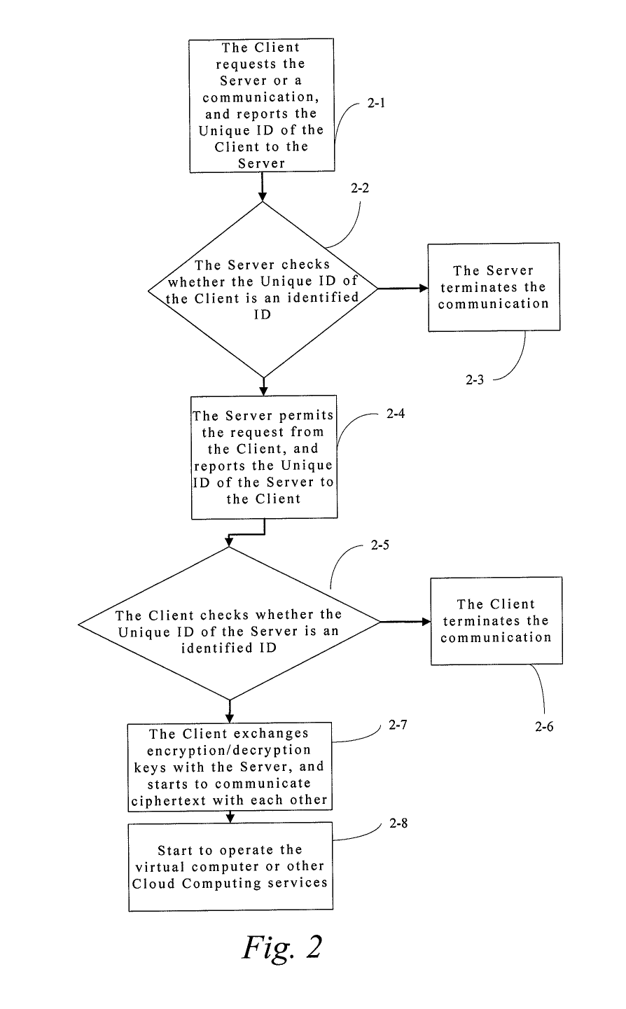

Referring to FIG. 2, once the Machine-Machine Authentication is not approved between any Client 3 and the Server 1, the virtual computer 11 in the Server 1 is not able to operate. The Machine-Machine Authentication of the present invention is configured to build in smart card ICs in a motherboard of the Server 1 and the Client 3 respectively, or to provide an external smart card IC to the Server 1 and the Client 3, to provide authentication to hosts of both sides. That is, each virtual computer 11 of the Server 1 is provided with a Unique ID by the smart card IC of the Server 1, and the Client 3 is provided with a Unique ID by the smart card IC of the Client 3. The Server 1 and the Client 3 are cross authenticated by the Unique IDs as identified machines. A hacker cannot copy any identified machine in the Client side. Thus, the aforementioned method successfully blocks the hacker from stealing the data in Server 1 by copying the Client 3. On the contrary, by the Unique ID, the Client 3 is able to identify whether the Server 1 is an identified machine, and the hacker cannot steal the user data from Client 3 by copying the identified Server 1.

Since the Server 1 and the Client 3 both have smart card ICs, one important advantage of the smart card IC is to safely store confidential data inside the smart card IC. Thus, the encryption key and the decryption key can be safely stored in the smart card IC, and the communication channel between the Server 1 and the Client 3 can be encrypted. Therefore, the hacker cannot store data by internet wiretapping. The present universal encryption/decryption algorithm performs at a high security level and is adapted by various military departments and banks, which is one of the highest-level security specifications around the world.

The Machine-Machine Authentication method is described as follows.

2-1: The Client 3 requests the Server 1 for a communication, and reports the Unique ID of the Client 3 to the Server 1;

2-2: The Server 1 checks whether the Unique ID of the Client 3 is an identified ID;

2-3: If the Unique ID of the Client 3 is not an identified ID, then the Server 1 terminates the communication;

2-4: If the Unique ID of the Client 3 is an identified ID, then the Server 1 permits the request from the Client 3, and reports the Unique ID of the Server 1 to the Client 3;

2-5: The Client 3 checks whether the Unique ID of the Server 1 is an identified ID;

2-6: If the Unique ID of the Server 1 is not an identified ID, then the Client 3 terminates the communication;

2-7: If the Unique ID of the Server 1 is an identified ID, then the Client 3 exchanges encryption/decryption keys with the Server 1, and starts to communicate ciphertext (i.e. encrypted text) with each other;

2-8: The Server 1 and the Client 3 start to operate the virtual computer or other Cloud Computing services.

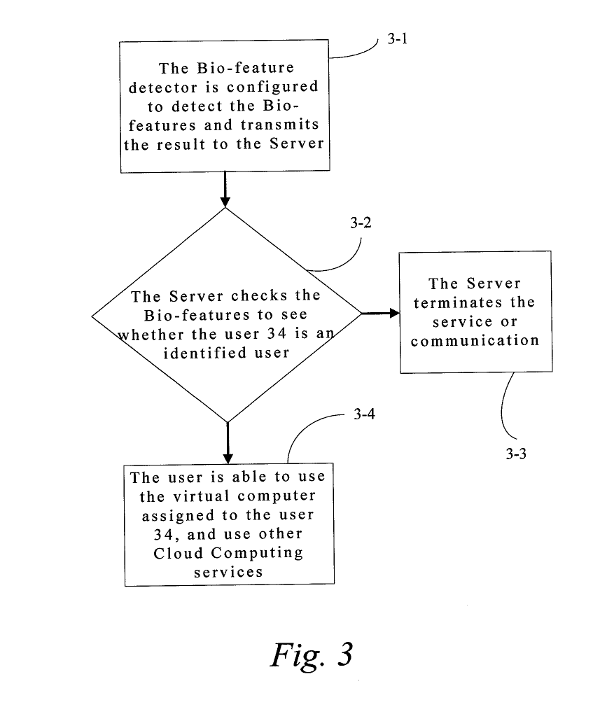

FIG. 3 shows the Human-Machine Authentication method of the present invention. A Bio-feature detector 35 is applied to process fingerprint recognition, face recognition, pupil recognition, and etc. Then the virtual computer 11 of the Server 1 is able to identify the user 34, or the Bio-feature detector 35 of the Client 3 is able to identify the user 34. If the Bio-feature identification in the Client 3 fails, the Client 3 is unable to activate the communication with the virtual computer 11 of the Server 1. Thus, if the Bio-feature identification fails, it is unable to activate the virtual computer 11 or other Cloud Computing services.

The Machine-Machine Authentication method and the Human-Machine Authentication method for the Cloud Computing of the present invention provide the smart card IC to ensure the cross authentication between the Server 1 and the Client 3 (the Machine-Machine Authentication), the security of the encryption/decryption keys of communication channel, and the Human-Machine Authentication with Bio-features. Thus, authentication between the physical machines in Client 3 and the virtual computer in the Server 1 can be achieved, and the data security of the Cloud Computing is ensured.

The flow chart of Human-Machine Authentication method is described as follows.

3-1: The Bio-feature detector 35 is configured to detect the Bio-features and transmits the result to the Server 1;

3-2: The Server 1 checks the Bio-features to see whether the user 34 is an identified user;

3-3: If the user 34 is not an identified user, then the Server 1 terminates the service or communication;

3-4: If the user 34 is an identified user, then the user 34 is able to use the virtual computer assigned to the user 34, and use other Cloud Computing services.

The aforementioned description brings up embodiments for explaining the present invention but does not intend to limit the scope of the present invention. Any equivalent embodiment and modification after reading the present invention shall be deemed to be within the scope of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A Machine-Machine Authentication method for Cloud Computing, comprising the steps of:
a. launching a communication request by a Client to a Server, in which the Client reports a Unique ID of the Client to the Server;
b. checking whether the Unique ID of the Client is an identified ID; if the Unique ID of the Client is not an identified ID, the Server terminates the communication; if the Unique ID of the Client is an identified ID, the Server permits the communication with the Client and reports a Unique ID of the Server to the Client;
c. checking whether the Unique ID of the Server is an identified ID; if the Unique ID of the Server is not an identified ID, the Client terminates the communication; if the Unique ID of the Server is an identified ID, the Server exchanges and assigns a encryption/decryption key with the Client for starting to communicate ciphertext with each other; and
d. processing a virtual computer or other Cloud Computing services by the Server and the Client.

2. A Human-Machine Authentication method for Cloud Computing, comprising the steps of:
a. detecting a bio-feature of an user by a bio-feature detector for sending the bio-feature to a Server;
b. checking the bio-feature by the Server to verify whether the user is an identified user; if the user is not an identified user, the Server terminates the service or communication; if the user is an identified user, the user is permitted to use a virtual computer belonging to the user or other Cloud Computing services.

3. The Machine-Machine Authentication method for Cloud Computing as claimed in claim 1, wherein the Server and the Client both apply a Smart Card IC for identification.

4. The Human-Machine Authentication method for Cloud Computing as claimed in claim 2, wherein the bio-features are detected by one of a bio-feature detector, including a fingerprint recognition device, a face recognition device, and a pupil recognition device.
